(19) United States
(12) Patent Application Publication
(10) Pub. No.: US 2024/0310132 A1
(43) Pub. Date: Sep. 19, 2024

(54) LOUVERS FOR COOLING TOWER, COOLING TOWER SYSTEMS, AND METHODS OF PREVENTING COOLING TOWER FROM FREEZING

(71) Applicant: Inner Mongolia Helin Power Generation Co., Ltd., Hohhot City (CN)

(72) Inventors: Cong GUO, Hohhot City (CN); Zhihong XIE, Hohhot City (CN); Chunlei FU, Hohhot City (CN); Jishan LIU, Hohhot City (CN); Xiaohui ZHANG, Hohhot City (CN)

(21) Appl. No.: 18/492,431

(22) Filed: Oct. 23, 2023

(30) Foreign Application Priority Data
Mar. 14, 2023 (CN) 2023102435971

(51) Int. Cl. F28F 19/00; F25D 21/04; F28F 25/12

(52) U.S. Cl. CPC F28F 19/006; F25D 21/04; F28F 25/12; F28F 2265/14

(57) ABSTRACT

A cooling tower louver, including an adjustment module and a fixing module, is provided. Particularly, the adjustment module includes length adjustment assemblies, an angle adjustment assembly, and coupling assemblies, in which the angle adjustment assembly is positioned above the length adjustment assemblies, the coupling assemblies are positioned on a side of the angle adjustment assembly. Furthermore, the fixing module includes slat assemblies and a framework, in which the slat assemblies are located in the framework. Through the collaborative efforts of the adjustment module and the fixing module, it's possible to maintain the cooling tower's air intake capacity while minimizing the ingress of rainwater during wet conditions. The cooling tower system effectively mitigates the risk of equipment damage due to freezing during the winter season. Moreover, the anti-freezing method for the cooling tower streamlines the anti-freezing strategy and offers enhanced convenience in terms of regulation and control.

### CROSS-REFERENCE TO RELATED APPLICATIONS

The present application claims priority from China patent application serial number 2023102435971 filed Mar. 14, 2023 and the disclosure of which is incorporated herein by reference in its entirety.

### FIELD OF THE INVENTION

The present invention relates to the field of freeze protection of cooling towers, more particularly, a louver for cooling tower, a cooling tower system and a method of preventing cooling towers from freezing.

### BACKGROUND OF THE INVENTION

A cooling tower serves to cool water through indirect contact between air and water, utilizing water as a circulating coolant to absorb and dissipate heat into the atmosphere, making the cooling water recyclable. However, conventional cooling towers encounter challenges during winter use. In early winter, with substantial day-night temperature fluctuations, the cooling tower must release heat during the relatively warmer daytime, which may prevent the cooling tower louver from closing completely. Consequently, if it rains during the day, rainwater can infiltrate the cooling tower. Overnight, the collected rainwater may freeze, potentially damaging the equipment within the cooling tower. In late winter, the external environment is consistently cold. If the cooling tower louver remains partially open, the exposed pipeline on the windward side is susceptible to freezing and cracking, leading to the malfunction of a specific cooling tower section. Furthermore, existing cooling tower louvers inadequately protect against winter's cold winds, especially during periods of high wind speed. Moreover, the current anti-freezing measures for cooling towers are intricate and challenging to regulate and control.

### SUMMARY OF THE INVENTION

This section provides a concise overview of select aspects and preferred embodiments of the present invention. To maintain clarity and precision, some simplifications or omissions may occur in this section, the abstract, and the title. However, it is crucial to note that such simplifications or omissions do not constrain the scope of the present invention or its stated objectives.

The present invention addresses the challenges encountered with conventional cooling tower louvers, cooling tower systems, and anti-freezing methods. These issues include the inability of cooling tower louvers to maintain adequate air intake while preventing rainwater ingress, as well as the complexity and challenging regulation of existing cooling tower systems and anti-freezing methods.

Therefore, the present invention aims to provide a cooling tower louver capable of maintaining the cooling tower's air intake while minimizing rainwater ingress during raining days.

In accordance with a first aspect of the present invention, the present invention provides a cooling tower louver, including:
an adjustment module, including length adjustment assemblies, an angle adjustment assembly and coupling assemblies, in which the angle adjustment assembly is positioned above the length adjustment assemblies and the coupling assemblies are disposed on a side of the angle adjustment assembly; and
a fixing module, including slat assemblies and a framework, in which the slat assemblies are positioned within the framework.

As a preferred embodiment of the cooling tower louver of the present invention, each of the length adjustment assembly includes an adjustment shaft, an adaptive component, and an adjustment plate, in which the adaptive component is positioned on the adjustment shaft and the adjustment plate is situated on one side of the adjustment shaft.

As a preferred embodiment of the cooling tower louver of the present invention, the adjustment shaft includes an adjustment platform, a limit ring, a first rotating shaft, and a spring, in which the limit ring is located on one side of the adjustable platform, the first rotating shaft is positioned on one side of the limit ring, and the spring is disposed on an outer side of the first rotating shaft.

As a preferred embodiment of the cooling tower louver of the present invention, the adaptive component includes a pressing plate, a connecting plate, and an adaptive box, in which the connecting plate is positioned on one side of the pressing plate, the adaptive box is situated on one side of the connecting plate; furthermore, the pressing plate includes extrusion holes and the extrusion holes are formed in the pressing plate, and the adaptive box includes a leaking hole and a water pouring plane, in which the water pouring plane is located on one side of the leaking hole.

As a preferred embodiment of the cooling tower louver of the present invention, the adjustment plate includes a first pressing surface, a second pressing surface, a third pressing surface, and a limit bar, in which the second pressing surface is located on one side of the first pressing surface, the third pressing surface is positioned on one side of the second pressing surface, and the limit bar is disposed on the first pressing surface.

As a preferred embodiment of the cooling tower louver of the present invention, the angle adjustment assembly includes a drive motor, a drive rod, connecting rods, and a connecting block, in which the drive rod is positioned on one side of the drive motor, the connecting rods are positioned below the drive rod, the connecting block is positioned below the connecting rods. Each of the coupling assemblies includes a coupling rod and coupling clips, in which the coupling clips are disposed on one side of the coupling rod, and each coupling clip includes a coupling pin hole and clip plates, in which the clip plates are positioned on one side of the coupling pin hole.

As a preferred embodiment of the cooling tower louver of the present invention, each of the slat assemblies includes a first slat and a second slat, in which the second slat is positioned within the first slat. The first slat includes a slat slot and a limit block, in which the limit block is positioned within the slat slot; and the second slat includes a limit bar slot, in which the limit bar slot is positioned at the bottom of the second slat.

As a preferred embodiment of the cooling tower louver of the present invention, the framework includes slat clips, first rotating shaft holes, and a connecting plate slot, in which the first rotating shaft holes are positioned on one side of the slat clips, the connecting plate slot is disposed on one side of the first rotating shaft holes. Each slat clip includes a second rotating shaft and clip posts, in which the clip posts are positioned on one side of the second rotating shaft.

In accordance with a second aspect of the present invention, a cooling tower system is presented. The system is able to mitigate freezing damage to cooling tower equipment during winter months.

In order to solve the above technical problems, the present invention provides a cooling tower system, including a cooling tower louver and a cooling tower, in which the cooling tower has a plurality of the cooling tower louver positioned at the bottom of the cooling tower.

As a preferred embodiment of the cooling tower of the present invention, the cooling tower includes a water return device, a return water temperature setting unit, and a temperature monitoring unit, in which the return water temperature setting unit is disposed on the water return device and the temperature monitoring unit is positioned on a side of the cooling tower louvers.

In accordance with a third aspect of the present invention, the present invention provides a method of preventing a cooling tower from freezing, which can optimize an anti-freezing strategy of a cooling tower and facilitate regulation.

In order to solve the above technical problems, the method presented by the present invention including employing a cooling tower system, more particularly, including:
uniformly setting a return water temperature of the cooling tower;
closing the cooling tower louvers at the head and the tail of the cooling tower once the ambient temperature is below than a certain value; and
closing all of the cooling tower louvers of the cooling tower once the ambient temperature is below than a certain value and the return water temperature of the cooling tower is lower than the pre-set value to protect the cooling tower system.

The advantages of the present invention are as follows: With the cooling tower louver, cooling tower system, and the cooling tower anti-freezing method, the collaborative action between the adjustment module and the fixing module effectively maintains the cooling tower's air intake volume while minimizing rainwater ingress during rainy days. Additionally, the cooling tower system minimizes the risk of equipment damage due to freezing in winter. Furthermore, the cooling tower anti-freezing method optimizes the cooling tower's anti-freezing strategy and simplifies its regulation and control.

### BRIEF DESCRIPTION OF THE DRAWINGS

In order to more clearly describe the technical scheme of the embodiments of the present invention, a brief introduction will be given to the accompanying drawings required in the description of the embodiments. It is apparent that the accompanying drawings in the following description are only some embodiments of the present invention. Those of ordinary skill in the art can also obtain other drawings according to these drawings without creative work. In the drawings:

FIG. 1 depicts a schematic diagram showing the first structure of a cooling tower louver;

FIG. 2 depicts a sectional diagram of a cooling tower louver;

FIG. 3 depicts a schematic diagram showing the structure of an adjustment shaft and an adjustment plate;

FIG. 4 displays a schematic diagram showing the structure of an adaptive component;

FIG. 5 is a sectional diagram of an adaptive box;

FIG. 6 depicts a schematic diagram showing the second structure of a cooling tower louver;

FIG. 7 is an enlarged diagram of an angle adjustment assembly;

FIG. 8 displays a schematic diagram showing the structure of a coupling assembly;

FIG. 9 depicts a schematic diagram showing the structure of a coupling clip;

FIG. 10 displays a schematic diagram showing the structure of a slat assembly;

FIG. 11 is a partially enlarged diagram of a slat assembly;

FIG. 12 is a sectional diagram of a framework;

FIG. 13 is a schematic diagram showing the structure of a slat clip; and

FIG. 14 is a schematic diagram showing the structure of a cooling tower system.

### DETAILED DESCRIPTION

In order to make the foregoing objectives, features, and advantages of the present invention more obvious and understandable, the specific implementations of the present invention are described in detail with reference to the accompanying drawings of this specification.

Many specific details are set forth in the following description to facilitate a full understanding of the present invention. However, the present invention can also be implemented in other ways different from those described herein, and those skilled in the art can do so without departing from the connotation of the present invention. Therefore, the present invention is not limited by the specific embodiments disclosed below.

Secondly, the term “one embodiment” or “an embodiment”, as used herein, refers to a specific feature, structure, or characteristic that may be incorporated into at least one implementation of the present invention. The term “in one embodiment” appearing in various sections of this specification does not necessarily refer to the same embodiment, nor does it represent a separate or selective embodiment that is mutually exclusive with other embodiments.

### Embodiment 1

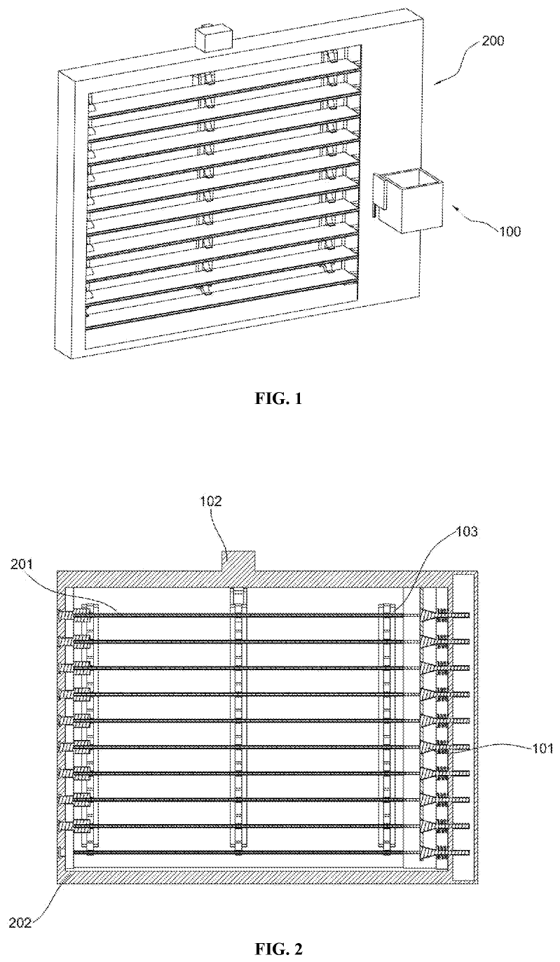

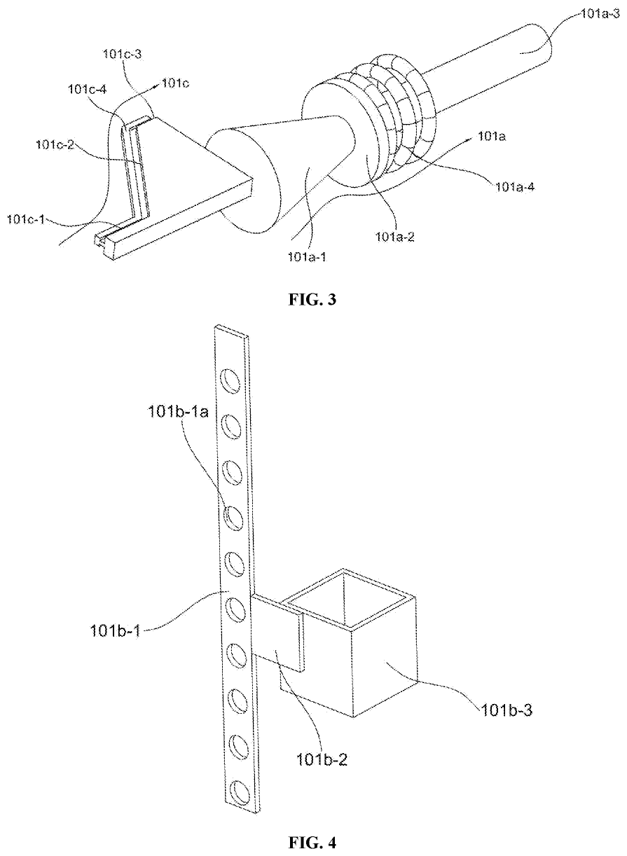

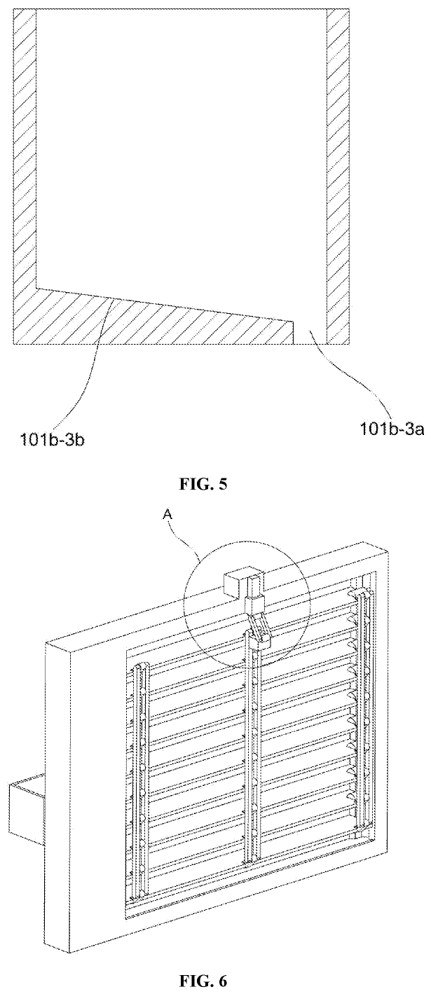

Referring to FIG. 1 to FIG. 5, a first embodiment of the present invention is provided. This embodiment provides a cooling tower louver, specifically including:
an adjustment module 100, including length adjustment assemblies 101, an angle adjustment assembly 102, and coupling assemblies 103, in which the angle adjustment assembly 102 is positioned above the length adjustment assemblies 101 and the coupling assemblies 103 are disposed on one side of the angle adjustment assembly 102; and
a fixing module 200, wherein the fixing module 200 includes slat assemblies 201 and a framework 202, in which the slat assemblies 201 are located within the framework 202.

Furthermore, each length adjustment assembly 101 includes an adjustment shaft 101a, an adaptive component 101b, and an adjustment plate 101c. The adaptive component 101b is positioned on the adjustment shaft 101a. The adjustment plate 101c is located on a side of the adjustment shaft 101a. The adjustment shaft 101a includes an adjustment platform 101a-1, a limit ring 101a-2, a first rotating shaft 101a-3, and a spring 101a-4. The limit ring 101a-2 is located on a side of the adjustable platform 101a-1. The first rotating shaft 101a-3 is positioned on a side of the limit ring 101a-2. The spring 101a-4 is disposed on an outer side of the first rotating shaft 101a-3.

It is worth to note that the adjustment platform 101a-1 is a circular truncated cone, with a bottom radius twice that of the upper radius. Particularly, the upper radius of the adjustment platform 101a-1 equals to that of the first rotating shaft 101a-3 and the bottom radius of the adjustment platform 101a-1 equals to the diameter of the limit ring 101a-2. Moreover, one end of the spring 101a-4 is connected to the limit ring 101a-2, while the other end is linked to the framework 202.

Preferably, the adaptive component 101b includes a pressing plate 101b-1, a connecting plate 101b-2, and an adaptive box 101b-3. The connecting plate 101b-2 is positioned on a side of the pressing plate 101b-1, while the adaptive box 101b-3 is situated on a side of the connecting plate 101b-2. The pressing plate 101b-1 includes extrusion holes 101b-1a, which are formed in the pressing plate 101b-1. The adaptive box 101b-3 includes a leaking hole 101b-3a and a water pouring plane 101b-3b, in which the water pouring plane 101b-3b is located on one side of the leaking hole 101b-3a. Furthermore, the adjustment plate 101c includes a first pressing surface 101c-1, a second pressing surface 101c-2, a third pressing surface 101c-3, and a limit bar 101c-4. The second pressing surface 101c-2 is located on a side of the first pressing surface 101c-1, while the third pressing surface 101c-3 is positioned on a side of the second pressing surface 101c-2. The limit bar 101c-4 is disposed on the first pressing surface 101c-1.

It is worth to note that the connecting plate 101b-2 is fixed on the pressing plate 101b-1 and the adaptive box 101b-3 is fixed on the connecting plate 101b-2. Each extrusion hole 101b-1a has a diameter equal to the bottom radius of the adjustment platform 101a-1. The leaking hole 101b-3a is an elongated through hole. The water pouring plane 101b-3b is inclined at an angle of 10 degrees relative to a horizontal plane. The first pressing surface 101c-1 is flat, and the second pressing surface 101c-2 forms a 135-degree angle with the first pressing surface 101c-1. The second pressing surface 101c-2 smoothly extends from the first pressing surface 101c-1 to the third pressing surface 101c-3. The third pressing surface 101c-3 is parallel to the first pressing surface 101c-1. The limit bar 101c-4 is a “T”-shaped bar and fixed on the first pressing surface 101c-1, the second pressing surface 101c-2, and the third pressing surface 101c-3. The first pressing surface 101c-1 is in contact with the bottom of the second slat 201b when there is no water in the adaptive box 101b-3.

### Embodiment 2

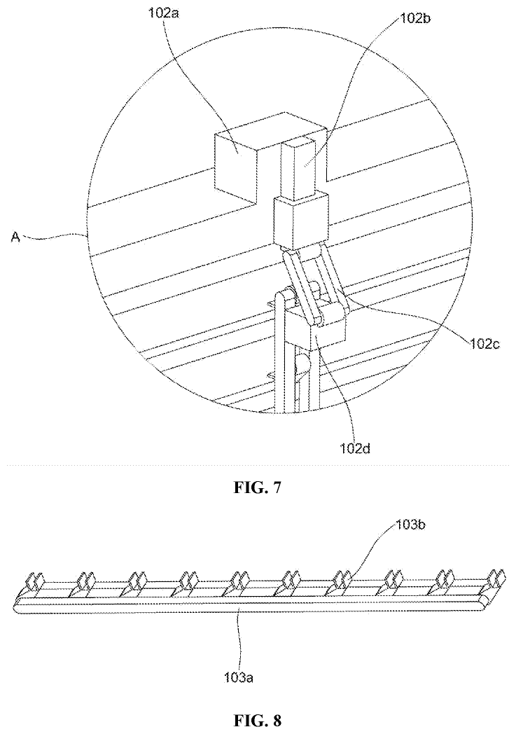

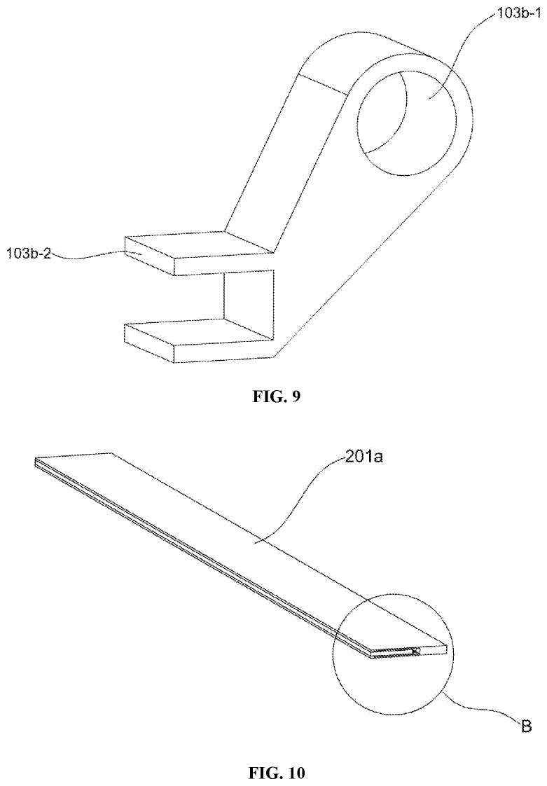

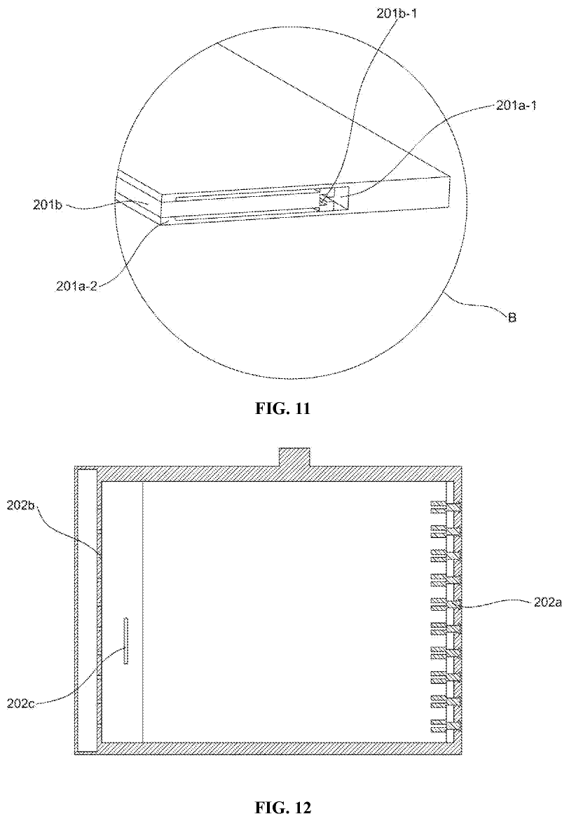

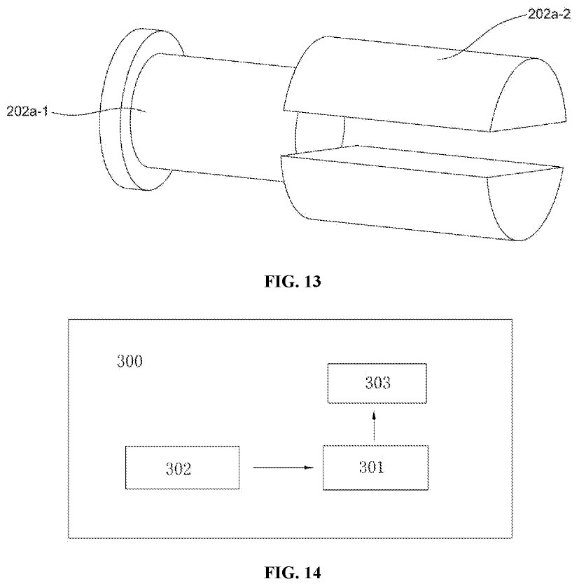

Referring to FIG. 1 to FIG. 13, a second embodiment of the present invention is presented. This embodiment builds upon the previous embodiment.

Specifically, the angle adjustment assembly 102 includes a drive motor 102a, a drive rod 102b, connecting rods 102c, and a connecting block 102d. The drive rod 102b is positioned on a side of the drive motor 102a, while the connecting rods 102c are positioned below the drive rod 102b and the connecting block 102d is positioned below the connecting rods 102c. Each coupling assembly 103 includes a coupling rod 103a and coupling clips 103b. The coupling clips 103b are located on a side of the coupling rod 103a. Each coupling clip 103b includes a coupling pin hole 103b-1 and two clip plates 103b-2. The clip plates 103b-2 are positioned on a side of the coupling pin hole 103b-1.

It is important to note that the drive motor 102a is positioned above the framework 202. The drive rod 102b is powered by the drive motor 102a and has the capability to move up and down. One end of each connecting rod 102c is connected to the drive rod 102b, while the other end is attached to the connecting block 102d. The connecting block 102d is securely mounted on the coupling rod 103a. The coupling clips 103b are hinged to the coupling rod 103a. The space between the two clip plates 103b-2 corresponds to the thickness of a first slat 201a.

In this embodiment, when an operator moves the drive rod 102b downward, it exerts pressure on the connecting rods 102c, causing them to press down on the connecting block 102d. This downward force on the connecting block 102d initiates the rotation of the coupling rod 103a around the axial direction of the first rotating shaft 101a-3. Consequently, the first slat 201a is driven to rotate vertically around the axial direction of the first rotating shaft 101a-3 and become vertical.

Further, each slat assembly 201 includes the first slat 201a and a second slat 201b. The second slat 201b is positioned within the first slat 201a. The first slat 201a includes a slat slot 201a-1 and a limit block 201a-2. The limit block 201a-2 is positioned within the slat slot 201a-1. The second slat 201b includes a limit bar slot 201b-1, which is positioned at the bottom of the second slat 201b.

It should be noted that the first slat 201a and the second slat 201b are interconnected with a sliding mechanism. The second slat 201b has the ability to slide within the slat slot 201a-1 until it reaches the bottom of the second slat 201b, making contact with the limit block 201a-2. The limit bar slot 201b-1 is shaped like “T” and is designed to match the size of the limit bar 101c-4 are in sliding connection, in which the limit bar slot 201b-1 and the limit bar 101c-4 are slidingly connected.

Preferably, the framework 202 includes slat clips 202a, first rotating shaft holes 202b, and a connecting plate slot 202c, the slat clips (202a) are positioned on a first side of the framework (202), the first rotating shaft holes (202b) are positioned on a second side of the framework (202) and the connecting plate slot (202c) is positioned on the same side with the first rotating shaft holes (202b), and the first side is opposite to the second side. Each slat clip 202a includes a second rotating shaft 202a-1 and clip posts 202a-2, in which the clip posts 202a-2 are located on a side of the second rotating shaft 202a-1.

It is important to note that the slat clips 202a and the framework 202 are slidingly connected, while the first rotating shaft holes 202b and the first rotating shafts 101a-3 are slidingly connected. The connecting plate slot 202c is also slidingly connected with the connecting plate 101b-2. Moreover, the connecting plate slot 202c has a length greater than that of the connecting plate 101b-2.

In this embodiment, when it rains in the area where the cooling tower is situated, rainwater will collect in the adaptive box 101b-3. If the rainfall is below the water leaking rate of the leaking hole 101b-3a, the weight of the adaptive box 101b-3 remains relatively unchanged. However, if the rainfall exceeds the water leaking rate of the leaking hole 101b-3a, rainwater will accumulate in the adaptive box 101b-3. As a result, the weight of the adaptive box 101b-3 increases, causing the extrusion holes 101b-1a to apply downward pressure on the adjustment platform 101a-1. Under this vertical pressure, the adjustment platforms 101a-1, guided by their side surfaces, press the springs 101a-4, enabling the adjustment plates 101c to fit into the slat slots 201a-1. During this process, the bottom of the second slats 201b is pressed against the second pressing surfaces 101c-2, causing the second slats 201b to extend beyond the slat slots 201a-1. This extension of the second slats 201b serves to reduce the amount of rainwater entering the cooling tower.

It is important to highlight that when the rainfall continues to increase until the adaptive box 101b-3 is filled with rainwater, the adaptive box 101b-3 reaches its maximum weight. During this time, the extrusion holes 101b-1a apply pressure to the adjustment platforms 101a-1, causing them to make contact with the limit rings 101a-2. The adjustment plates 101c, which are affixed to the adjustment platforms 101a-1, press against the second slats 201b until the third pressing surfaces 101c-3 come into contact with the bottoms of the second slats 201b. This results in the second slats 201b achieving their maximum extension, effectively preventing any additional rainwater from entering the cooling tower. If the rainfall diminishes, the weight of the adaptive box 101b-3 decreases, and the adjustment platforms 101a-1 are retracted due to the pulling force of the springs 101a-4. The second slats 201b are also pulled back by the limit bars 101c-4.

### Embodiment 3

Referring to FIG. 1 to FIG. 10, a third embodiment of the present invention is provided. This embodiment provides a cooling tower system, including a cooling tower louver. More particularly, the system includes:
a cooling tower 300 having a plurality of cooling tower louvers positioned around its bottom.

Specifically, the cooling tower 300 includes a water return device 301, a return water temperature setting unit 302, and a plurality of temperature monitoring unit 303. The return water temperature setting unit 302 is positioned on the water return device 301 and the temperature monitoring unit 303 is positioned on a side of the cooling tower louvers.

It is worth to note that the water return device 301 includes a plurality of water return pipeline. The return water temperature setting unit 302 is configured to control a return water temperature of the water return device 301. Some of the temperature monitoring units 303 are disposed along the water return pipelines, while others are positioned on a side of the cooling tower louvers.

In this embodiment, an operator can monitor the temperatures around the water return device 301 and the cooling tower louvers using the temperature monitoring units 303 and set up the return water temperature of the water return device 301 by using the return water temperature setting unit 302.

### Embodiment 4

Referring to FIG. 1 to FIG. 10, a fourth embodiment of the present invention is provided. This embodiment provides an anti-freezing method of preventing a cooling tower system from freezing, the method includes employing a cooling tower system, more particularly, it includes:
uniformly setting a return water temperature of the cooling tower;
closing the cooling tower louvers at the head and the tail of the cooling tower once the ambient temperature is below than a certain value; and
closing all of the cooling tower louvers of the cooling tower once the ambient temperature is below than a certain value and the return water temperature of the cooling tower is lower than the pre-set value to protect the cooling tower system.

It is important to highlight that compared to the approach of individually configuring temperatures, the method of uniformly defining the return water temperature is more straightforward and operationally convenient, resulting in better control of the return water temperature for the circulating water. This approach ensures that the opening degree of the cooling tower louvers is smaller on the windward side and larger on the leeward side, maintaining consistent adjustment actions and directions for the entire tower. This uniformity helps avoid issues that can occur when cooling tower louvers are controlled separately. In such cases, the louvers on the windward or leeward side might be opened too widely or too narrowly, leading to more complex adjustment scenarios, triggering anti-freezing mechanisms, and potentially causing system shutdowns. Moreover, it becomes more challenging to control the temperature of the entire tower's circulating water, which can affect the equipment's safe operation.

It is essential to emphasize that when the external ambient temperature falls below a specific threshold, the first and last cooling tower louvers will remain closed. In situations where adjacent cooling tower louvers are not in operation, the first and last louvers experience a more rapid drop in temperature, making it challenging to maintain control. This condition also poses a higher risk of freezing and cracking in the heat dissipation pipeline. Therefore, the first and last cooling tower louvers are forcibly closed under such circumstances, effectively preventing freezing damage to the pipelines at these positions.

Importantly, it should be noted that the construction and arrangement of the present invention shown in multiple different exemplary implementations are only exemplary. Although only a few implementations are described in detail herein, those referring to this invention should easily understand that, many modifications are possible (for example, changes in sizes, scales, structures, shapes, and proportions of various elements, as well as parameter values (such as temperatures and pressures), mounting and arrangement, use of materials, colors, and orientation) without departing from the novelty teaching and advantages of the subject described in this application. For example, elements shown as a whole can be composed of multiple portions or elements, and positions of the elements can be inverted or otherwise changed. Furthermore, natures or quantities or positions of discrete elements can be changed or altered. Therefore, all such modifications are intended to fall within the scope of the present invention, and an order or a sequence of any process or method step can be changed or reordered according to the alternative implementations. In the claims, any provision about “device plus function” is intended to cover a structure described herein and performing the function, and is not only structurally equivalent but also an equivalent structure. Without departing from the scope of the present invention, other substitutions, modifications, changes, and omissions can be made in the designs, running statuses, and arrangements of the exemplary implementations. Therefore, the present invention is not limited to specific implementations, but extends to various modifications that still fall within the scope of the claims attached.

In addition, in order to provide a concise description of the exemplary implementations, it is possible not to describe all features of actual embodiments (namely, those features that are not related to a currently considered optimal mode of executing the present invention, or those features that are not related to the implementation of the present invention).

It should be understood that in a development process of any practical implementation, such as in any engineering or design project, a large number of specific implementation decisions can be made. Such development efforts may be complex and time-consuming, but for those ordinarily skilled persons benefiting from this invention, there is no need for excessive experimentation. The development efforts will be routine tasks of design, manufacturing, and production.

It should be noted that the above embodiments are merely illustrative of the technical solutions of the present invention, and are not intended to be limit. Although the present invention is described in detail with reference to the preferred embodiments, it should be understood that those of ordinary skill in the art can make modifications or equivalent replacements to the technical solutions of the present invention without departing from the spirit and scope of the technical solutions of the present invention. These modifications and equivalent replacements shall fall within the scope of claims of the present invention.

What is claimed is:

1. A cooling tower louver, comprising:
an adjustment module (100), comprising a plurality of length adjustment assembly (101), an angle adjustment assembly (102), and a plurality of coupling assembly (103), wherein the angle adjustment assembly (102) is positioned above the length adjustment assemblies (101), the coupling assemblies (103) are disposed on a side of the angle adjustment assembly (102); and
a fixing module (200), comprising a plurality of slat assembly (201) and a framework (202), wherein the slat assemblies (201) are positioned within the framework (202).

2. The cooling tower louver according to claim 1, wherein the length adjustment assembly (101) comprises an adjustment shaft (101a), an adaptive component (101b), and an adjustment plate (101c), wherein the adaptive component (101b) is positioned on the adjustment shaft (101a);
and the adjustment plate (101c) is positioned on a side of the adjustment shaft (101a).

3. The cooling tower louver according to claim 2, wherein the adjustment shaft (101a) comprises an adjustment platform (101a-1), a limit ring (101a-2), a first rotating shaft (101a-3), and a spring (101a-4), wherein the limit ring (101a-2) is positioned on a side of the adjustable platform (101a-1), the first rotating shaft (101a-3) is positioned on a side of the limit ring (101a-2), and the spring (101a-4) is positioned on the outer side of the first rotating shaft (101a-3).

4. The cooling tower louver according to claim 2, wherein the adaptive component (101b) comprises a pressing plate (101b-1), a connecting plate (101b-2), and an adaptive box (101b-3), wherein the connecting plate (101b-2) is positioned on a side of the pressing plate (101b-1) and the adaptive box (101b-3) is positioned on a side of the connecting plate (101b-2);
the pressing plate (101b-1) comprises extrusion holes (101b-1a), wherein the extrusion holes (101b-1a) are formed within the pressing plate (101b-1); and
the adaptive box (101b-3) comprises a leaking hole (101b-3a) and a water pouring plane (101b-3b), wherein the water pouring plane (101b-3b) is located on a side of the leaking hole (101b-3a).

5. The cooling tower louver according to claim 4, wherein the adjustment plate (101c) comprises a first pressing surface (101c-1), a second pressing surface (101c-2), a third pressing surface (101c-3), and a limit bar (101c-4), wherein the second pressing surface (101c-2) is positioned on a side of the first pressing surface (101c-1), the third pressing surface (101c-3) is positioned on a side of the second pressing surface (101c-2), and the limit bar (101c-4) is positioned on the first pressing surface (101c-1).

6. The cooling tower louver according to claim 5, wherein the angle adjustment assembly (102) comprises a drive motor (102a), a drive rod (102b), connecting rods (102c), and a connecting block (102d), wherein the drive rod (102b) is positioned on a side of the drive motor (102a), the connecting rods (102c) are positioned below the drive rod (102b), and the connecting block (102d) is positioned below the connecting rods (102c);
the coupling assembly (103) comprises a coupling rod (103a) and coupling clips (103b), wherein the coupling clips (103b) are located on one side of the coupling rod (103a);
wherein the coupling clip (103b) comprises a coupling pin hole (103b-1) and clip plates (103b-2), and the clip plates (103b-2) are positioned on a side of the coupling pin hole (103b-1).

7. The cooling tower louver according to claim 6, wherein the slat assembly (201) comprises a first slat (201a) and a second slat (201b), wherein the second slat (201b) is located in the first slat (201a);
wherein the first slat (201a) comprises a slat slot (201a-1) and a limit block (201a-2) and the limit block (201a-2) is positioned within the slat slot (201a-1); and
the second slat (201b) comprises a limit bar slot (201b-1), wherein and the limit bar slot (201b-1) is positioned at the bottom of the second slat (201b).

8. The cooling tower louver according to claim 7, wherein the framework (202) comprises slat clips (202a), first rotating shaft holes (202b), and a connecting plate slot (202c), wherein the slat clips (202a) are positioned on a first side of the framework (202), the first rotating shaft holes (202b) are positioned on a second side of the framework (202) and the connecting plate slot (202c) is positioned on the same side with the first rotating shaft holes (202b), wherein the first side is opposite to the second side;
each of the slat clips (202a) comprises a second rotating shaft (202a-1) and clip posts (202a-2), wherein the clip posts (202a-2) are positioned on a side of the second rotating shaft (202a-1).

9. A cooling tower system, comprising the cooling tower louver according to claim 1, and further comprising:
a cooling tower (300), wherein a plurality of cooling tower louvers is positioned at the bottom of the cooling tower;
wherein the cooling tower (300) comprises a water return device (301), a return water temperature setting unit (302), and a temperature monitoring unit (303), wherein the return water temperature setting unit (302) is disposed on the water return device (301) and the temperature monitoring unit (303) is positioned on a side of the cooling tower louvers.

10. An anti-freezing method of preventing a cooling tower from freezing, comprising employing the cooling tower system according to claim 9, and further comprising:
uniformly setting a return water temperature of the cooling tower;
closing the cooling tower louvers at the head and the tail of the cooling tower once the ambient temperature is below than a certain value; and
closing all of the cooling tower louvers of the cooling tower once the ambient temperature is below than a certain value and the return water temperature of the cooling tower is lower than the pre-set value to protect the cooling tower system.
